(19) United States
(12) Patent Application Publication
(10) Pub. No.: US 2002/0085300 A1
(43) Pub. Date: Jul. 4, 2002

(54) Information storage device with a removable cartridge, and a method of operating it

(76) Inventors: Allen T. Bracken, Layton, UT (US); Theodore J. Smith, Layton, UT (US); Jeffery D. Penman, Ogden, UT (US); Todd R. Shelton, Syracuse, UT (US); David S. Greenhalgh, Roy, UT (US); Paul E. Jacobs, Ogden, UT (US); Spencer W. Stout, Layton, UT (US); Paul C. Kunz, Ogden, UT (US); Scott P. Thomas, Ogden, UT (US); Douglas S. Reynolds, Clinton, UT (US); David L. Jolley, Kaysville, UT (US); Ryan D. Osterhout, Layton, UT (US)

Correspondence Address: Jerry W. Mills, Esq., Baker Botts L.L.P., 2001 Ross Avenue, Dallas, TX, 75201-2980, US

(21) Appl. No.: 09/755,961

(22) Filed: Jan. 4, 2001

(51) Int. Cl. G11B 15/18

(52) U.S. Cl. 360/69

(57) ABSTRACT

An information storage device (10) includes a drive module (14) releasably coupled to an interface module (13), where an information storage cartridge (11) can be removably inserted into the drive module in an approximately vertical direction. The drive module has a light source and magnifying lens which highlight indica located on the cartridge. Guide structure ensures that the cartridge can be inserted only with a single proper orientation. The drive module includes a display (236) which provides operational status information, and which is visible through an opening (411) provided in the interface module. The interface module has at least two ports (307, 308) conforming to a selected communication protocol, to permit the information storage device to be daisy chained with other compatible devices. A button (301) for initiating cartridge removal is actuated in an approximately vertical direction.

### TECHNICAL FIELD OF THE INVENTION

This invention relates in general to an information storage device and, more particularly, to an information storage device in which information is stored in a removable cartridge, and a method of operating such an information storage device.

### BACKGROUND OF THE INVENTION

Over the past 20 years, computer technology has evolved very rapidly. One aspect of this evolution has been a progressively growing demand for increased storage capacity in memory devices, especially where the information storage medium is disposed in some form of removable cartridge. In this regard, just a little over a decade ago, the typical personal computer had a floppy disk drive which accepted floppy disk cartridges that contained a 5.25″ disk having a storage capacity up to about 720 kilobytes (KB) per cartridge. Not long thereafter, these devices gave way to a new generation of floppy disk drives which accepted smaller floppy disk cartridges that contained a 3.5″ disk having higher storage capacities up to about 1.44 megabytes (MB) per cartridge.

Subsequently, as the evolution continued, a further significant increase in storage capacity was realized in the industry by the introduction of a storage system having a removable cartridge containing a floppy-type disk with storage capacities on the order of 100 MB to 250 MB. Systems of this type are commercially available under the tradename ZIP from Iomega Corporation of Roy, Utah, which is the assignee of the present application. Thereafter, another significant increase in storage capacity was realized by the introduction of a system having removable cartridges with storage capacities on the order of 1 to 2 gigabytes (GB). Systems of this type are also available from Iomega Corporation, under the tradename JAZ. The cartridges used in this system had a hard disk in an unsealed housing, with a read/write head in the drive. These two products have each enjoyed immense commercial success. Nevertheless, the demand for still greater storage capacities in removable cartridges continues to progressively increase, such that there is a current need for cartridges capable of storing 5 GB to 20 GB, or even more.

The types of removable cartridges discussed above each contain a rotatably supported storage medium within an unsealed housing. The read/write heads, with associated circuitry and support structure, are in the drive rather than in the cartridge. Significantly higher storage capacities exist in hard disk technology of the type used in non-removable hard disk drives, where the disk and head are both disposed within a sealed housing. Due in part to the fact that a high-capacity hard disk is highly sensitive to environmental factors such as dust and static electricity, a sealed housing is needed for the hard disk itself, as well as for some associated components, such as the read/write heads, which must be within the sealed housing and thus within the cartridge. Prior system have been developed which use hard disk technology within a sealed housing in a removable cartridge, and these systems have been generally adequate for their intended purposes, but there are still some disadvantages which it would be desirable to overcome.

One such disadvantage is that the removable cartridges are normally inserted into the drive unit in an approximately horizontal direction. Consequently, especially where the drive unit is a standalone device sitting on a flat surface such as a table top, the drive unit will have a tendency to slide horizontally on the surface as the cartridge is being inserted. Although this can be minimized to some extent by using connectors between the cartridge and drive unit that have low contact and swiping forces, the use of such connectors tends to result in decreased reliability with respect to the electrical contact provided between the connectors. Further, even where such connectors are used, there is still a significant tendency for the drive unit to slide horizontally. Consequently, as a practical matter, the insertion of a cartridge into a standalone drive unit usually requires two hands, which is disadvantageous.

A related problem is that, in many existing drive units, a button which is manually pressed to initiate cartridge removal is also operated in a horizontal direction. Thus, operation of this button also tends to urge the drive unit to slide horizontally along the surface on which it is sitting. Still another related problem is that, when the button is pressed to initiate cartridge removal, the cartridge may have a tendency to slide out of the drive unit and fall on the floor before it can be manually gripped, with the associated risk that the cartridge may be damaged or may pick up dirt or dust that will affect its operation.

A further problem is that, where the drive unit is coupled to a host system through a port which conforms to a specified communication protocol, situations may arise where it is desirable to couple one or more other devices to the same port of the host system, for use with the same protocol. In such a situation, it is typically necessary to incur the expense of purchasing and installing a further device commonly known as a hub or a repeater, which provides additional ports that conform to the protocol of interest. A further consideration is that such a hub or repeater typically needs separate access to 120 VAC power, which may not be readily available in some circumstances.

Still another problem is that existing drive units may permit a cartridge to be inserted with an incorrect orientation, with the associated possibility of damage to the cartridge and/or the drive unit, as well as the possibility of operator frustration and dissatisfaction. Still another problem is that most existing drive units provide little or no status information, other than a “busy” light which blinks or stays on continuously whenever information is being written to or read from the cartridge.

### SUMMARY OF THE INVENTION

From the foregoing, it may be appreciated that a need has arisen for an information storage device which can store information in a removable cartridge and which solves one or more of the problems discussed above.

One form of the present invention involves a receiving unit which includes: structure for supporting the receiving unit as a freestanding unit on an upwardly facing surface; a port for facilitating communication with a host system; and a cartridge receiving portion that can removably receive an information storage cartridge, the cartridge receiving portion being configured so that cartridge insertion and removal is effected in directions which are substantially vertical.

A different form of the present invention involves a receiving unit which includes: a port for facilitating communication with a host system; a cartridge receiving portion that can removably receive an information storage cartridge; and a display which provides status information regarding operation of the receiving unit.

Still another form of the present invention involves a receiving unit which includes: a cartridge receiving portion that can removably receive a cartridge; and structure configured to highlight indicia present on a cartridge disposed in the cartridge receiving portion.

A different form of the present invention involves a receiving unit which includes: a cartridge receiving portion that can removably receive an information storage cartridge; and first and second ports which each facilitate communication according to a common protocol.

Yet another form of the present invention involves a receiving unit which includes a drive module, an interface module, and structure operable to releasably couple the drive and interface modules together, the drive module having a cartridge receiving portion that can removably receive an information storage cartridge, and the interface module having a port which facilitates communication with a host system.

Still another form of the present invention involves: an information storage cartridge having a housing with an exterior surface thereon, and having a mass information storage media within the housing; a receiving unit which includes a cartridge receiving portion that can removably receive the cartridge, the receiving portion including a recess which receives at least a portion of a cartridge; and cooperating guide structure on the housing and within the recess to guide insertion of the cartridge into the recess in a manner so that the exterior surface of the cartridge housing, which is separate from the guide structure, is free from contact with the cartridge receiving portion.

A different form of the present invention involves: an information storage cartridge which contains a mass information storage media and which has a connector; and a receiving unit which includes a connector and a cartridge receiving portion with a recess that can removably receive at least a portion of the cartridge, the connectors being in engagement when the cartridge is removably received in the cartridge receiving portion, and wherein the cartridge and the cartridge receiving portion include cooperating guide structure which facilitates alignment of the connectors during cartridge insertion and which prevents insertion of the cartridge into the cartridge receiving portion with an incorrect orientation, the guide structure including at least two guide rails which extend parallel to a direction of insertion and which are each provided on a respective one of the cartridge and the cartridge receiving portion, and at least two grooves which are each provided on the other of the cartridge and the cartridge receiving portion, and which each slidably receive a respective guide rail.

### BRIEF DESCRIPTION OF THE DRAWINGS

A better understanding of the present invention will be realized from the detailed description which follows, taken in conjunction with the accompanying drawings, in which:

FIG. 1 is a diagrammatic view showing a host computer system coupled to an information storage device which embodies the present invention and which includes a removable cartridge, and also showing a plurality of other types of devices into which the cartridge from the information storage device can be removably inserted;

FIG. 2 is a diagrammatic view showing pertinent internal structure of the information storage device and host system of FIG. 1;

FIG. 3 is a diagrammatic perspective view of the information storage device of FIG. 1;

FIG. 4 is a diagrammatic perspective view showing the front and top sides of an interface module which is a component of the information storage device of FIG. 1;

FIG. 5 is a diagrammatic perspective view showing the rear and bottom sides of the interface module of FIG. 4;

FIG. 6 is a diagrammatic perspective view of a drive module which is a component of the information storage device of FIG. 1;

FIG. 7 is a diagrammatic side view of the drive module of FIG. 6;

FIG. 8 is a diagrammatic rear view of the drive module of FIG. 6;

FIG. 9 is a diagrammatic top view of the drive module of FIG. 6; and

FIG. 10 is a diagrammatic perspective view of the removable cartridge from the information storage device of FIG. 1.

### DETAILED DESCRIPTION OF THE INVENTION

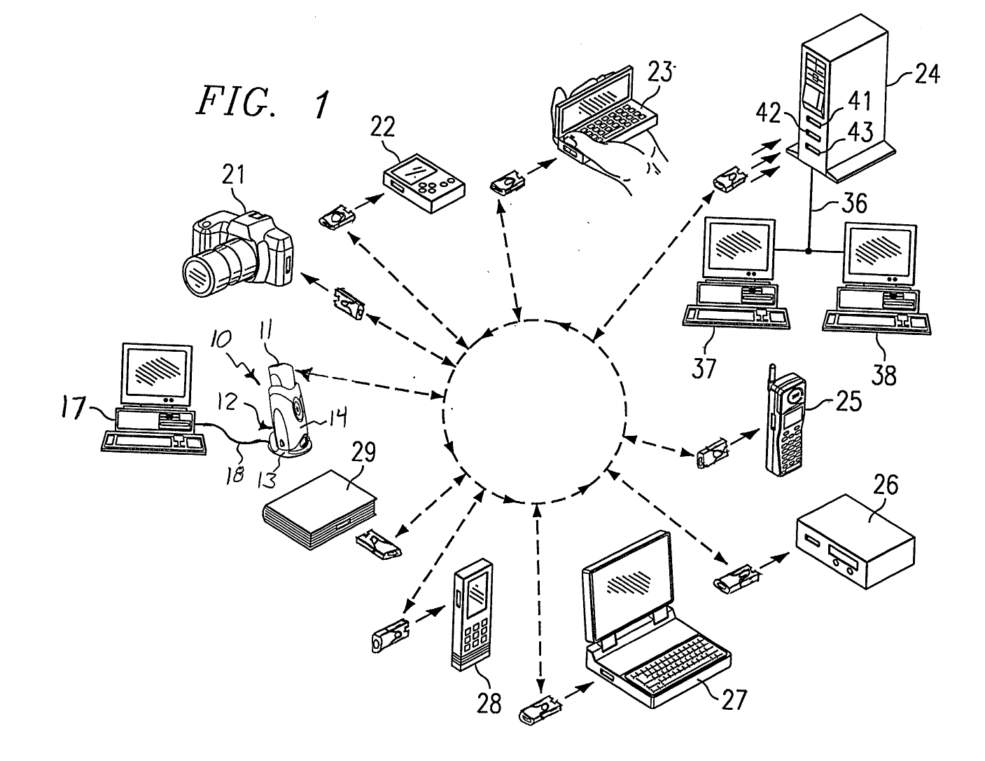

FIG. 1 is a diagrammatic view showing an information storage device 10 which embodies the present invention, and which is coupled by a cable 18 to a host computer system 17. The information storage device 10 includes a receiving unit or cradle 12, and an information storage cartridge 11 which is removably inserted into the cradle 12. The cradle 12 includes a base or interface module 13 and a drive module 14, which are physically separate parts that are releasably coupled to each other. The cartridge 11 and the drive and interface modules 13-14 of the cradle 12 are described in more detail later. FIG. 1 also shows a variety of other devices 21-29, into which the cartridge 11 can be removably inserted. Each of the devices 21-29 has, as an integral part thereof, structure which corresponds functionally to at least part of the cradle 12.

In FIG. 1, the devices 21-29 are shown only by way of example, to give a sense of the wide variety of types of devices with which the cartridge 11 could be used. In this regard, the device 21 is a digital camera, the device 22 is a portable game device, and the device 23 is a handheld computer. The device 23 might alternatively be a unit of the type commonly known as a personal digital assistant (PDA). The device 24 is a server which is coupled by a home computer network 36 to several home computers, two of which are shown at 37 and 38. It will be noted that the server 24 has three slots or receiving units 41-43, which can each removably receive a respective different cartridge of the type indicated at 11. The server does not need to have more than one of the receiving units 41-43, but three units are shown in FIG. 1 in order to emphasize that use of more than one can be advantageous.

The device 25 is a cellular telephone, and the device 26 is a video recording unit which is capable of reading digital video information from the cartridge 11, and/or storing digital video information in the cartridge 11. The device 26 may, for example, be a video recording device similar to the device which is commercially available under the tradename TiVo. The device 27 is a portable “notebook” computer, and the device 28 is a global positioning satellite (GPS) device. The device 28 is responsive to radio signals from not-illustrated satellites for using known techniques to make a precise determination of the current location of the device 28 on the surface of the earth. The cartridge 11 may contain map information for the region in which the GPS device 28 is currently located, so that the device 28 can display a map on its liquid crystal display (LCD) screen, and then indicate on that map the current location of the device 28. The device 29 is an electronic book.

As mentioned above, the various devices 21-29 shown in FIG. 1 are merely exemplary, and it will be recognized that the cartridge 11 could also be used with other types of devices, including variations and modifications of the specific devices shown in FIG. 1. For example, it would be possible for the cartridge 11 to be removably inserted into a compact disk player, a music synthesizer, or an Internet access device designed for use with a television, such as a device of the type commercially available under the tradename WebTV. It will also be recognized from FIG. 1 that the digital information stored in the cartridge 11 can represent a variety of different things, including but not limited to data, photographs, video images, sounds such as music, and so forth.

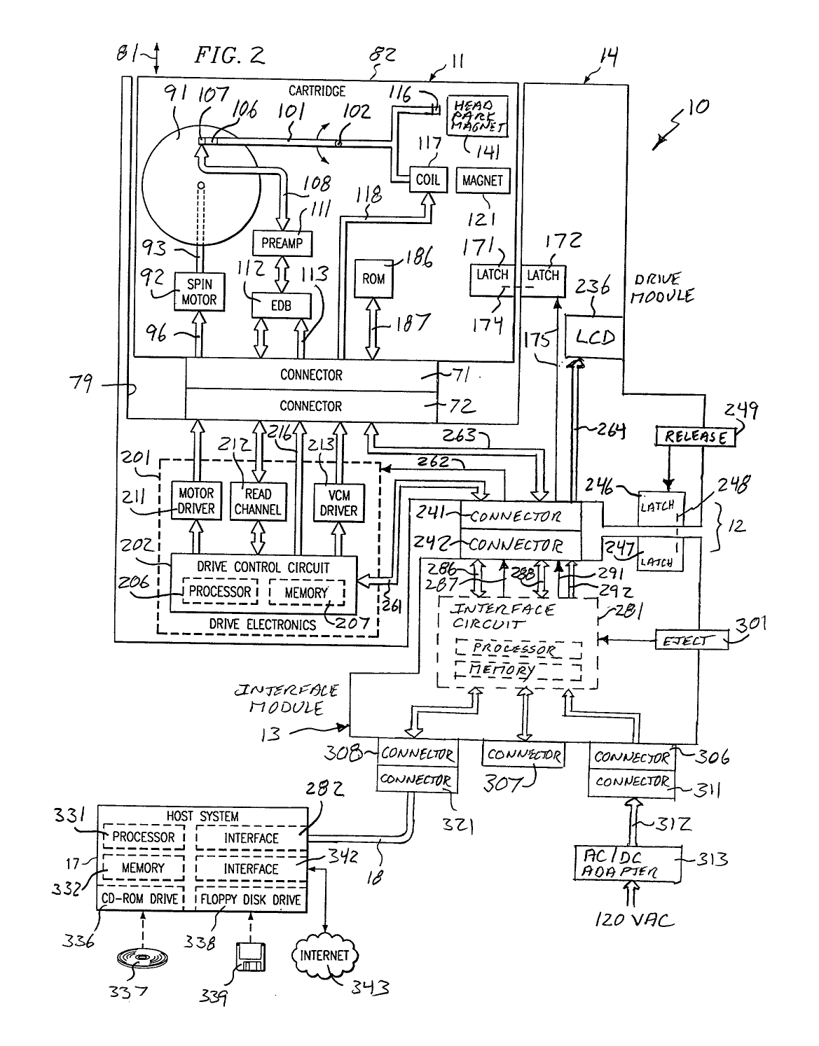

FIG. 2 is a diagrammatic view of the information storage device 10 and the host computer system 17 of FIG. 1, and depicts selected components from the cartridge 11, drive module 14, interface module 13 and host system 17. FIG. 2 depicts selected components which will help convey an accurate understanding of the present invention, and is not intended to depict every component within the host computer system 17 and the information storage device 10.

As shown in FIG. 2, the cartridge 11 includes a connector 71, and the drive module 14 includes a connector 72, the connectors 71-72 each being a known type of connector. The connectors 71-72 matingly engage each other when the cartridge 11 is removably disposed in the drive module 14, and serve as communication ports that allow the cartridge and the drive module to exchange electrical signals.

The cartridge 11 is inserted into and removed from the drive module 14 in approximately vertical directions, which are indicated diagrammatically in FIG. 2 by a double headed arrow 81. In order to ensure proper mating of the connectors 71-72 as the cartridge 11 is inserted into the drive module 14, the cartridge 11 must be in accurate alignment with respect to the drive module 14 as its insertion movement reaches completion. In the disclosed embodiment, a recess 79 is provided in the drive module 14, and receives a portion of the cartridge 11. The recess 79 effects initial alignment between the cartridge 11 and drive module 14 as the cartridge is inserted into the drive module. There is some additional structure which is not shown in FIG. 2, and which will be described later, that ensures the cartridge 11 and drive module 14 are very accurately aligned during the final phase of the insertion movement, as the connectors 71 and 72 approach each other. The cartridge 11 has a housing 82. Within the housing 82, the cartridge has a hard disk 91 mounted on a spindle 93, which can be rotatably driven by a spin motor 92. The disk 91 and the spindle 93 together form a disk assembly. The spin motor 92 is controlled by electrical signals received at 96 through the connector 71. The hard disk 91 has a substrate made of a known material such aluminum, glass, plastic, or embossed plastic. On the side of the disk 91 which is visible in FIG. 2, the disk 91 has a layer of a known magnetic material, which stores digital information. An actuator arm 101 is supported for pivotal movement on the housing 82 by a bearing or bushing at 102. At one end, the actuator arm 101 has a suspension 106 which supports a read/write head 107, so that the head is closely adjacent the surface of the disk 91. The suspension 106 is of a known type, and is therefore not described here in detail. The head 107 is also a component of a known type, such as an inductive head, a magnetoresistive (MR) head, or a giant magnetoresistive (GMR) head.

For convenience and clarity in describing the present invention, the cartridge 11 in the embodiment of FIG. 2 is described as having only a single hard disk 91 with a magnetic surface on only one side thereof, and as having only a single read/write head 107. However, those skilled in the art will recognize that it would be possible to also use the opposite side of the disk 91, in which case a second head would be provided. Further, it would be possible to provide at least one additional disk on the spindle 93, with each additional disk having one or more additional heads associated with it. The present invention is compatible with all such configurations.

The head 107 is electrically coupled at 108 to inputs of a preamplifier 111, and the outputs of the preamplifier 111 are coupled to the connector 71 through an electrostatic discharge buffer (EDB) 112. The buffer 112 is a commercially available device, and therefore not described here in detail. Alternatively, however, the buffer 112 could be a custom device of comparable function. The buffer 112 receives control signals at 113 through the connector 71. When the cartridge 11 is withdrawn from the drive module 14, the buffer 112 is disabled, and electrically isolates the preamplifier 111 and the head 107 from the pins of the connector 71, in order to protect the preamplifier 111 and the head 107 from electrostatic energy external to the cartridge. When the cartridge 11 is received in the drive module 14, the buffer 112 receives control signals at 113 which cause it to electrically couple the preamplifier 111 to the connector 71, in order to facilitate system operation.

The end of the actuator arm 101 remote from the head 107 is bifurcated to define two legs, one of which has at the outer end thereof a magnetically permeable part 116, and the other of which has at the outer end thereof a coil 117. The coil 117 is electrically coupled at 118 to pins of the connector 71. The cartridge 11 also includes a stationary magnet 121 which is located close to the coil 117. The electrical signals supplied at 118 to the coil 117 cause the coil to create an electromagnetic field, which interacts with the magnetic field of the magnet 121 so as to effect pivotal movement of the actuator arm 101 about the pivot 102. The arm 101, head support 106, head 107, pivot 102, and coil 117 may be referred to as an actuator.

When the disk 91 is rotating at a normal operational speed, the rotation of the disk induces the formation, between the disk surface and the head 107, of an air cushion which is commonly known as an air bearing. Consequently, the head 107 floats on the air bearing while reading and writing information to and from the disk, without direct physical contact with the disk. As the arm 101 is pivoted due to interaction between the magnetic fields of the coil 117 and the magnetic 121, the head 107 moves approximately radially with respect to the disk. Thus, through relative movement of the head 107 and the disk 91 resulting from rotation of the disk 91 and pivotal movement of the arm 101, the head 107 can be moved to a position aligned with any selected location on the operational portion of the surface of the disk 91.

When the disk 91 is at rest, the air cushion will not exist. Therefore, when the disk is at rest, the head 107 is moved to a special region of the disk at a radially inner portion thereof, adjacent the spindle 93. This is commonly known as the park position of the head. Since the cartridge 11 may be subjected to significant shocks during time periods when it is not received within the drive module 14, a parking arrangement is provided to help maintain the arm 101 and head 107 in the park position. In this regard, as previously mentioned, the arm 101 has a magnetically permeable part 116 thereon. As shown in FIG. 2, a head park magnet 141 is provided within the cartridge 11 at a location which is in close proximity to the magnetically permeable part 116 when the arm 106 and the head 107 are in the park position. The coil 117 and the magnet 121 are capable of exerting on the arm 101 a pivotal force which is in excess of the force acting between the magnetic 141 and the magnetically permeable part 116. As a result, the coil 117 and magnet 121 are capable of pivoting the arm 101 and head 107 away from the park position for purposes of normal operation.

Although the disclosed embodiment maintains the read/write head in the park position by moving it to a radially inner portion of the disk and by then maintaining it there through use of a magnetic field, it will be recognized that there are alternative ways in which the head could be maintained in a park position. For example, a ramp could cooperate with the arm supporting the head so as to move the head completely out of physical contact with the disk, and then a mechanical latch could be used to releasably prevent movement of the head away from the park position and back into contact with the disk.

It will be recognized that, as an alternative, a magnetic shunt of a known type could be provided within the drive module 14 so as to be in relatively close proximity to the head park magnet 141 when the cartridge 11 is removably disposed within the drive module 14. The shunt would interact with the magnet 141 and/or the field of magnet 141 when the cartridge 11 is disposed within the drive module 14, in a manner so as to weaken the effective strength of the magnetic field of magnet 141, thereby making it even easier for the coil 117 and magnet 121 to effect movement of the arm 101 and head 107 away from the park position.

In the embodiment of FIG. 2, the arm 101 is shown to be bifurcated at its right end, as discussed above. Arm 101 has been described in this manner in order to facilitate an understanding of the present invention, in particular by clarifying the separate and different functions carried out by the magnetically permeable part 116 and the coil 117. However, persons skilled in the art will recognize that it would alternatively be possible to use an arm which is not bifurcated, and which has the magnetically permeable part 116 and the coil 117 located thereon in relatively close proximity to each other.

A latching mechanism 171-172 is provided to releasably hold the cartridge 11 in the drive module 14. This avoids an unexpected withdrawal of the cartridge by an operator before the cradle 12 has time to effect parking of the read/write head, which in turn avoids the possibility of physical damage to the head and/or disk due to a physical shock which occurs when the cartridge has been removed from the cradle with the head still in contact with the disk. Even the removal of the cartridge could produce such physical damage if the head is still in contact with the disk during cartridge removal. The latching mechanism 171-172 also avoids an unexpected withdrawal of the cartridge by an operator while a read or write operation to the disk 91 is in progress, which in turn avoids unintended corruption of the data on the disk 91, for example because a transfer of data to the disk was interrupted before it could be completed. Reference numeral 171 designates a portion of the latching mechanism 171-172 which is part of the cartridge 11, and reference numeral 172 designates a portion of the latching mechanism which is part of the drive module 14. When the cartridge 11 is inserted into the drive module 14, the portions 171 and 172 mechanically engage each other in a manner described in more detail later, so as to automatically latch the cartridge 11 within the drive module 14. The latching effect between the latch portions 171-172 is indicated diagrammatically in FIG. 2 by the broken line at 174. The latch portion 172 disposed in the drive module 14 can release the latching effect 174 in response to an electrical signal supplied on a line 175, as discussed later.

The cartridge 11 includes a read-only memory (ROM) 186, which is coupled by lines 187 to the connector 71. The ROM 186 contains information about the cartridge 11, such as the storage capacity of the disk 91, the number of concentric tracks on the disk 91, the number of disks, the type of read/write head 107, the number of read/write heads, the format used for storing information on the disk 91, the information transfer rate for the head 107, information regarding the pivot 102 (such as whether it uses a bearing or bushing), information regarding the coil 117 (such as its inductance), information regarding the motor 92 (such as motor constants and inductances), servo information used to control tracking of the head 107 relative to the disk 91, blocks of firmware that can be used in the drive module 14, and so forth.

When the cartridge 11 is first plugged into the drive module 14, this information can be read from the ROM 186, so that the cradle 12 has the information that it needs about operational characteristics of the specific cartridge 11 which has been inserted, and can thus smoothly and successfully interact with that particular cartridge 11. Although the disclosed embodiment uses a ROM 186, it will be recognized that there are alternatives, such as the use of jumpers or micro switches instead of the ROM 186, or use of an encryption chip containing non-volatile memory instead of the ROM 186.

Turning now to the drive module 14, FIG. 2 shows that the module 14 includes a drive electronics circuit 201, which in general corresponds to certain electronic circuits of a known type that are commonly used in a standard hard disk drive for purposes of controlling functions that involve reading data from or writing data to the hard disk. In the disclosed embodiment, the drive electronics circuit 201 is implemented with an existing integrated circuit of a type commonly used in existing hard disk drives. The drive electronics circuit 201 includes a drive control circuit 202, which in turn includes a microprocessor 206 and a memory 207. The memory 207 is a diagrammatic and collective representation of multiple types of memory present within the circuit 202, including some ROM and also some random access memory (RAM). The ROM in the memory 207 may be implemented in the form of flash memory, in order to allow it to be updated. The drive electronics circuit 201 includes a motor driver circuit 211 of standard configuration, which is controlled by the drive control circuit 202, and which outputs control signals to the spin motor 92 in the cartridge 11 through the connectors 72 and 71.

The drive electronics circuit 201 also includes a read channel circuit 212 of standard configuration, which receives signals from the head 107 that have propagated through preamplifier 111, buffer 112, and connectors 71-72. The output of the read channel circuit 212 is supplied to the drive control circuit 202. The drive electronics circuit 201 further includes a voice coil motor (VCM) driver circuit 213 of standard configuration, which is controlled by the drive control circuit 202, and which has its output coupled through the connectors 72 and 71 to the lines 118 for the coil 117 in the cartridge 11. The drive control circuit 202 also outputs control signals on lines 216, which are coupled through connectors 72 and 71 to the lines 113 which serve as control inputs for the buffer 112.

The drive module 14 also includes a liquid crystal display (LCD) device 236, which is externally visible. The LCD 236 is used to provide an operator with status information regarding the operation of the information storage device 10, and is discussed in more detail later. The drive module 14 includes a connector 241 and the interface module includes a connector 242. The connectors 241-242 are of a known type, but could alternatively be custom connectors. The connectors 241-242 matingly engage each other, and serve as communication ports that allow the cartridge and cradle to exchange electrical signals.

A latching mechanism 246-247 is provided to releasably secure the drive module 14 to the interface module 13 while the connectors 241-242 are engaged. Reference numeral 246 designates the portion of the latching mechanism which is part of the drive module 14, and reference numeral 247 designates the portion of the latching mechanism which is part of the interface module 13. When the drive module 14 and the interface module 13 are moved so as to effect engagement between the connectors 241-242, the latching portions 246-247 mechanically engage each other, and cooperate in a manner which automatically latches the drive module 14 to the interface module 13, as discussed in more detail later. The latching effect between the latch portions 246-247 is indicated diagrammatically in FIG. 2 by the broken line at 248. The drive module 14 includes two manually operable release buttons 249. The two release buttons 249 are depicted diagrammatically in FIG. 2 by a single rectangular box. If both of the release buttons 249 are manually pressed, the latching effect 248 is canceled so that the connectors 241 and 242 can be separated, thus detaching the drive module 14 from the interface module 13. In the disclosed embodiment, this release is a direct mechanical release, but it could alternatively be an electromechanical release.

The drive control circuit 202 is coupled to the connector 241 through lines 261, and the drive electronics circuit 201 receives power from the connector 241 through a line 262. Lines 263 couple the connector 241 directly to the connector 72, and correspond to the lines 187 which provide access to the ROM 186. The line 175 runs from the connector 241 to the latch portion 172, and several lines 264 extend from the connector 241 to the LCD 236 in order to provide power and control signals to the LCD 236.

Turning to the interface module 13, the module 13 includes an interface circuit 281 which performs two basic types of functions. The first type of function is to handle operations which relate to the removability of the cartridge 11. This is because, as discussed above, the drive electronics circuit 201 in the disclosed embodiment is a known circuit designed for use in standard hard disk drives where the hard disk is not removable, and thus the drive electronics circuit 201 is not designed to handle functions relating to removability of the cartridge 11.

The second basic function of the interface circuit 13 is to facilitate communication with the host system 17 through the cable 18 according to a protocol defined by an interface 282 disposed within the host system 17. The interface 282 uses a selected one of several different protocols. These protocols include the industry standard IEEE 1394 protocol promulgated by the Institute of Electrical and Electronic Engineers (IEEE), the industry standard Universal Serial Bus (USB) protocol, the industry standard Small Computer System Interface (SCSI) protocol, and the industry standard Personal Computer Memory Card International Association (PCMCIA) protocol, which is also known as the PC Card protocol. Other protocols could alternatively be used for communication between the host system 17 and the interface circuit 281. In the disclosed embodiment, the interface circuit 281 communicates with the host system 17 using a selected one of these various protocols, which is the IEEE 1394 protocol. However, the invention is not limited to this particular protocol, and one of the other protocols discussed above could alternatively be used.

In this regard, if there was a need to convert the cradle 12 from the IEEE 1394 protocol to a different protocol, so that the cradle 12 could be used with a different host system configured for a different protocol, the interface module 13 would be detached from drive module 14, and replaced with a different interface module which would be effectively equivalent to the module 13, except to the extent that it was configured to be compatible with a different protocol, such as one of the USB, SCSI and PCMCIA protocols mentioned above. Thus, a given user might own a single drive module 14, but might also own two or more different interface modules which each conform to a respective different communication protocol. In the disclosed embodiment, communication between the drive module 14 and the installed interface module through the connectors 241-242 will always conform to a single predetermined protocol, regardless of which interface module is currently installed, whereas the protocol used by the interface module to communicate with a host system through the cable 18 will vary from interface module to interface module. Since communications between the drive module 14 and every compatible interface module always use the same predetermined protocol, the drive module is not aware of and does not care about which of several different protocols is currently being used between the attached interface module and a respective host system. Moreover, if a new communication protocol is developed in the industry and is adopted by host systems, the approach of interchangeable interface modules makes it possible to easily provide a new interface module that conforms to the new protocol and thereby permit existing cartridges 11 and drive modules 14 to be used with the host system that adopted the new protocol.

In the interface module 13 of FIG. 2, the interface circuit 281 includes a processor 283 and a memory 284. Memory 284 is a diagrammatic and collective representation of several different types of memory present in the interface circuit 281, such ROM and RAM. The interface circuit 281 is coupled to the drive control circuit 202 through lines 286, the connectors 242-241 and the lines 261. The interface circuit 281 provides power to the drive electronics circuit 201 through a line 287, the connectors 242-241 and the line 262. The interface circuit 287 communicates with the ROM 186 in the cartridge 11 through lines 288, connectors 242-241, lines 263, connectors 72-71 and lines 187. The interface circuit 281 can release the latching mechanism 171-172 through a line 291, the connectors 242-241 and the line 175. The interface circuit 281 provides power and control signals to the LCD 236 through lines 292, the connectors 242-241 and the lines 264.

The interface module 13 includes a manually operable eject button 301, which is operatively coupled to an input of the interface circuit 281. In response to manual actuation of the eject button 301, the interface circuit 281 winds up any read or write operation that is currently in progress with respect to the disk 91, and then effects a release of the latching mechanism 171-172 so that the cartridge 11 can be withdrawn from the drive module 14.

The interface module 13 further includes three connectors 306-308, which are each operationally coupled to the interface circuit 281. The connector 306 is a power connector, and is releasably engaged with a connector 311, which in turn is coupled through a cable 312 to an alternating current to direct current (AC/DC) adapter unit 313 of a known type. The adapter unit 313 is plugged into a standard 120 VAC wall socket, and supplies to the interface module 13 through the cable 312 an operational direct current voltage of 12 VDC. The interface module 13 uses a portion of this power for its own operation, and also supplies a portion of this power through the connectors 241-242 for use in operating the electronics disposed in the drive module 14 and the cartridge 11.

As discussed above, the interface module 13 communicates with the host system 17 using the IEEE 1394 protocol. Under this protocol, it is permissible for the information storage device 10 to use a limited amount of power received through the cable 18 from the host system, which would avoid the need for the connector 306, connector 311, cable 312 and adapter 313. However, while this is permissible if the information storage device 10 happens to be the only device coupled to the IEEE 1394 interface, it becomes problematic if one or more other devices are also coupled to and attempting to draw power from this interface, because the amount of available power is limited. Therefore, in order to ensure that the information storage device 10 is capable of trouble-free operation in virtually any IEEE 1394 configuration, the disclosed embodiment includes the connector 306, connector 311, cable 312 and adapter 313, so that the device 10 has its own source of power, and does not need to draw power from the 1394 interface. Moreover, this permits the device 10 to supply power received from the adapter 313 through the connector 307 to some other device, which would be problematic if the device 10 was attempting to rely on power drawn from the host system 17 through the 1394 interface.

The above-mentioned SCSI protocol does not support the provision of operating power through the cable 18. Some other protocols do support the provision of operating power through the cable 18, within specified limits, including the above-mentioned USB and PCMCIA protocols. In an interface module which operates according to one of these other protocols, and which does not need a level of power greater than the specified limits for the protocol, the connector 306, connector 311, cable 312 and adapter 313 could optionally be omitted.

The connector 308 is releasably coupled to a connector 321, which is at one end of the cable 18. The connector 307 is identical to the connector 308, and permits some other not-illustrated device that uses the IEEE 1394 protocol to be coupled to the IEEE 1394 interface 282 of the host system 17 through the interface module 13. Stated differently, the provision of the extra IEEE 1394 connector 307 permits the information storage device 10 and some other not-illustrated device to be coupled in a daisy chain fashion to the IEEE 1394 interface 282 of the host system 17. In this configuration, since the interface module 13 would be located between the host system and the other device, the interface module could control the allocation of available bandwidth between itself and the other device, whereas it has no control over bandwidth allocation when it and the other device are each coupled directly to the host system.

The hardware of the host system 17 is a standard computer, for example a commercially available computer of the type commonly known as a personal computer or a workstation. The host system 17 includes a microprocessor 331 and a memory 332, where the memory 332 includes RAM, ROM and a hard disk drive. The host system 17 also includes a compact disk read-only memory (CD-ROM) drive 336, which can removably receive a compact disk 337. The system 17 further includes a standard floppy disk drive 338, which can removably receive a floppy disk 339. The system 17 has an interface 342 such as a modem, through which it can be coupled to the Internet 343.

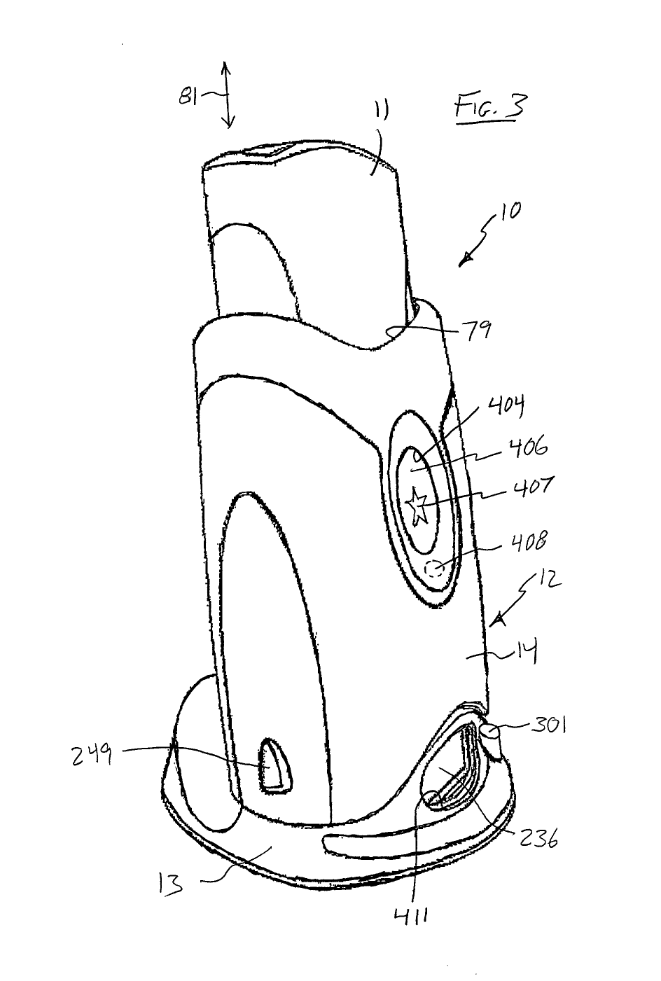

FIG. 3 is a diagrammatic perspective view of the information storage device 10 of FIG. 1, in an enlarged scale. The overall appearance of the device 10 in FIG. 3 represents one possible appearance. It will be recognized that the external appearance of the device could take a variety of other forms without departing from the scope of the present invention.

In FIG. 3, it can be seen that the cartridge 11 is removably inserted into the recess 79 in the drive module 14 of the cradle 12. As noted earlier, the insertion and removal of the cartridge 11 occur in directions indicated by the double-headed arrow 81. In the disclosed embodiment, the drive module 14 is oriented so that the directions represented by the arrow 81 form an angle of approximately 10°-15° with respect to a vertical reference. In FIG. 3, the drive module 14 is shown releasably coupled to the interface module 13. The drive module 14 has on opposite sides thereof the two manual release buttons 249 which were discussed above in association with FIG. 2, only one of which is visible in FIG. 3. When the two buttons 249 are simultaneously manually pressed, the drive module 14 can be separated from the interface module 13, in a manner described in more detail later.

As shown in FIG. 3, the drive module 14 has an opening 404 extending centrally through a front wall thereof, and has a magnifying lens 406 mounted within the opening 404. The cartridge 11 has a label, and the label has thereon a symbol 407 which, when the cartridge 11 is removably inserted into the drive module 14, is aligned with and visible through the lens 406. It will be recognized that, instead of providing the symbol 407 on a label, the symbol 407 could be provided directly on the housing of the cartridge. The symbol 407 shown in FIG. 3 has been arbitrarily selected to be a star, but it will be recognized that it could alternatively could be some other form of indica. For example, the symbol 407 might be a corporate name and/or a trademark of the company which manufactured the cartridge 11.

Inside the recess 79, and adjacent the lens 406, the drive module 14 has a light source which is shown diagrammatically by broken lines at 408. The light source 408 may, for example, be a light emitting diode (LED). The light source 408 illuminates the label on cartridge 11 that bears the symbol 407. Given that the symbol 407 is illuminated by the light source 408 and is also magnified by the lens 406, the symbol 407 tends to be quite noticeable to a person who is looking at the information storage device 10.

As described above, the drive module 14 includes an LCD display 236. As evident from FIG. 3, the LCD display 236 is disposed on a portion of the drive module 14 which extends down into the interface module 13, in a manner which will be discussed in more detail later. The interface module 13 has a window opening 411 through a front wall portion thereof, and the LCD display 236 is visible through the opening 411. The opening 411 has mounted therein a transparent window element made of plastic or shatterproof glass. The previously discussed eject button 301 is provided just to the right of the opening 411. The eject button 301 extends generally vertically, and is supported for vertical movement so that it is manually actuated by pressing it in a downward direction.

The information storage device 10 is designed for use as a freestanding unit which sits on an upwardly facing surface such as a table top, and which is coupled to the host system 17 by the flexible cable 18. With reference to the arrow 81, the fact that the cartridge 11 is inserted downwardly into the cradle 12 in a substantially vertical direction means that the insertion force manually exerted on the cartridge consists almost entirely of a vertical force component with virtually no horizontal force component. As a result, there is minimal tendency for the cradle 12 to slide horizontally across the surface it is resting on, even if a relatively strong downward force is being manually exerted. In fact, the connectors 71 and 72 between the cartridge 11 and drive unit 14 can be selected to have relatively high swiping and contact forces that ensure a reliable and robust electrical connection, and yet the cradle 12 will have little tendency to slide horizontally when a cartridge is inserted, even though a relatively large force must be manually exerted to cause the connectors to engage.

It will be noted from FIG. 3 that the vertical dimension or height of the cradle 12, including both the interface module 13 and the drive module 14, is significantly greater than the maximum dimension of the cradle 12 in any horizontal direction. The cradle 12 thus takes up a relatively small “footprint” of area on the upwardly facing surface which supports it.

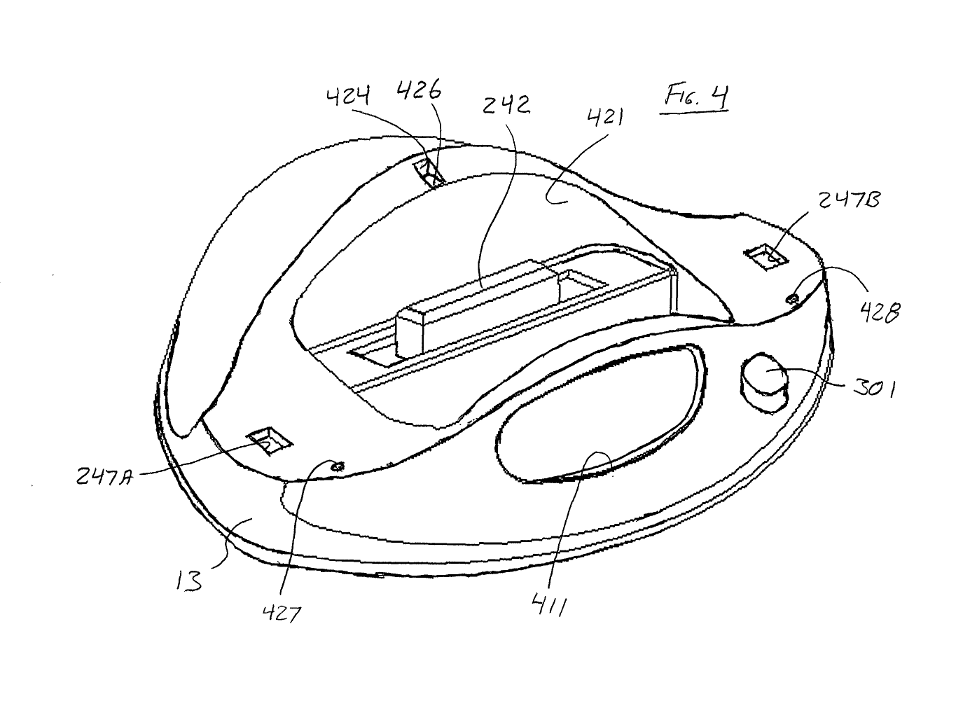

FIG. 4 is diagrammatic perspective view showing the front and top sides of the interface module 13, with the drive module 14 and cartridge 11 removed. Interface module 13 has a recess 421 which opens vertically downwardly thereinto from the top surface of the module housing. The connector 242 (FIGS. 2 and 4) is disposed within the recess 421, at a location spaced rearwardly from the front wall portion which has therein the window opening 411. The interface module 13 has, on opposite sides of the recess 421, two smaller recesses 247A and 247B, which are each a respective part of the latch portion 247 discussed above in association with FIG. 2.

Immediately behind the recess 421, the top surface of the housing of interface module 13 has a further recess 424, and the recess 424 has an upwardly facing surface 426 at the bottom thereof. The top surface of the housing also has two bosses 427 and 428 disposed on opposite sides of the recess 421, at locations spaced forwardly from the recesses 247A and 247B. The surface 426 and the bosses 427-428 engage three respective points provided on the housing of the drive module 14, as discussed again later, in order to provide three points of contact between the two housings that define the ultimate orientation of the two housings with respect to each other.

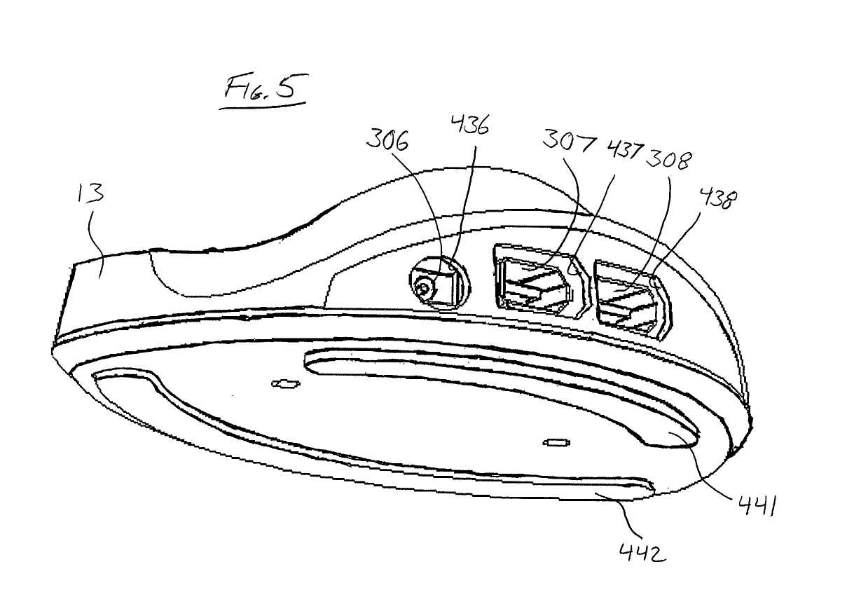

FIG. 5 is a further diagrammatic perspective view of the interface module 13, showing the rear and bottom sides thereof. The housing of the interface module 13 has in a rear wall thereof three openings 436-438, which respectively provide access to the three connectors 306-308 that were discussed above in association with FIG. 2. Two crescent-shaped rubber pads 441 and 442 are provided on opposite sides of the bottom surface of the housing of the module 13, in order to cushion the interface module 13 when it is sitting on a flat surface such as a table top, and in order to resist horizontal sliding movement of the interface module 13 relative to the surface on which it is sitting.

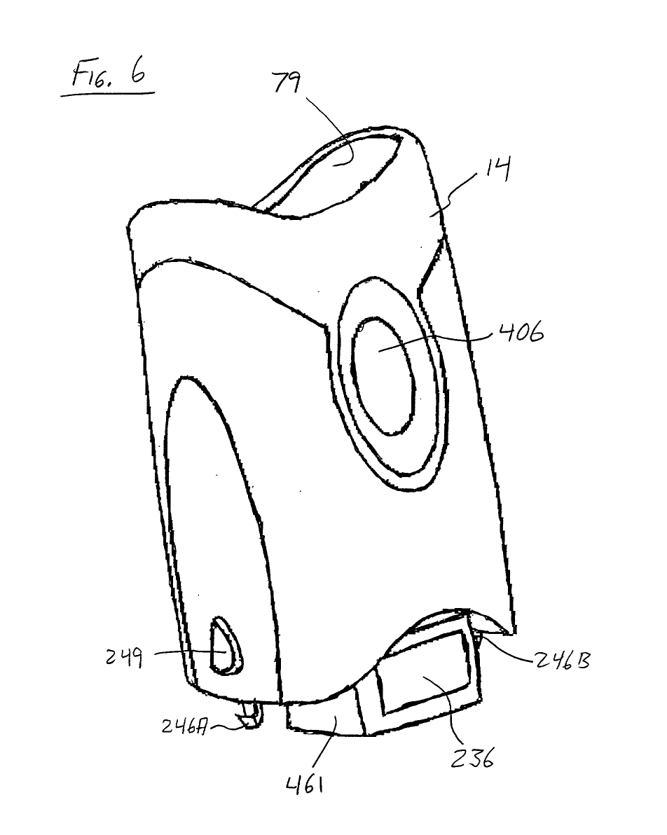

FIG. 6 is a diagrammatic perspective view of the drive module 14 by itself. In addition to the structure of the drive module 14 which has already been described above, it can be seen in FIG. 6 that the drive module 14 has a projection 461 which extends downwardly beyond the bottom of the housing of the drive module 14, and which has the LCD display 236 mounted on a front side thereof. The drive module 14 has on opposite sides of the projection 481 two pawls 246A and 246B, which are each part of the latch portion 246 discussed above in association with FIG. 2. The pawls 246A and 246B are each supported for limited movement toward and away from the projection 461, and are each biased to move away from the projection 461 by a respective spring which is not illustrated. The two release buttons provided on opposite sides of the drive module 14 are each operatively coupled to a respective one of the pawls. When the two release buttons 249 are simultaneously manually pressed, they each move a respective one of the pawls 246A-246B inwardly toward the projection 461.

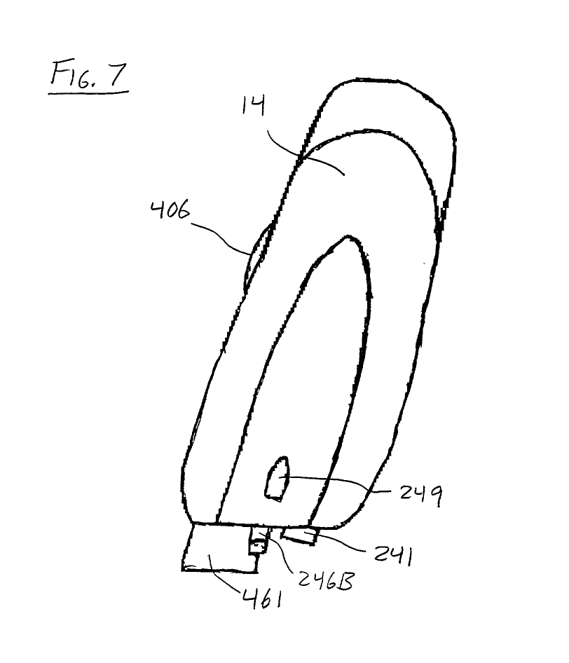

FIG. 7 is a diagrammatic side view of the drive module 14. FIG. 7 shows the connector 241 (FIG. 2) extending downwardly at a location spaced rearwardly of the projection 461, but the connector 241 does not extend down as far as the projection 461.

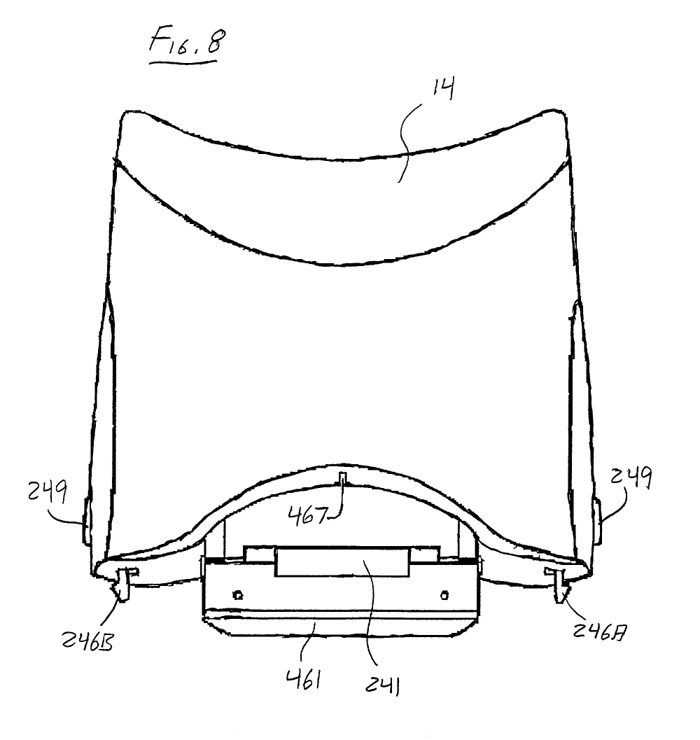

FIG. 8 is a diagrammatic rear view of the drive module 14. The release buttons 249 provided on opposite sides of the drive module 14 are both clearly visible in FIG. 8. Further, on the rear side of its bottom surface, the housing of the drive module 14 has a downward projection 467.

When the drive module 14 is to be releasably coupled to the interface module 13, the projection 461 on the drive module 14 is inserted downwardly into the recess 421, in the region between the connector 242 and the front wall having the window 411. The cooperation between the projection 461 and surfaces within the recess 421 help to guide the connector 241 on the drive module 14 into alignment with and then engagement with the connector 242 on the interface module 13.

As the drive module 14 continues to be moved downwardly, and after the connectors 241 and 242 have established electrical contact, the downward projection 467 (FIG. 8) on the drive module 14 engages the bottom surface 426 of the recess 424 in the interface module 13. Meanwhile, the bosses 427 and 428 engage respective locations on the underside of the housing of the drive module 14. The engagement of the bosses 427-428 with the underside of the housing of the drive module 14, in conjunction with the engagement of projection 467 with the surface 426, establishes three points of contact which define and maintain a proper orientation of the drive module 14 relative to the interface module 13.

As the drive module 14 is being inserted into the interface module 13, the pawls 246A and 246B respectively enter the recesses 247A and 247B, and are each temporarily urged in an inward direction due to engagement with the edges of the recesses as the insertion movement of the drive module 14 takes place. As the drive module 14 reaches its final position, the pawls 246A and 246B reach a position where they are urged outwardly by the not illustrated springs, so as to releasably lockingly engage the recesses 247A and 247B in a manner which maintains the drive module 14 in locking engagement with the interface module 13.

In order to subsequently release the drive module 14 from the interface module 13, the two release buttons 249 are simultaneously manually pressed so as to move the pawls 246A and 246B inwardly, thereby releasing the locking engagement between the pawls and the recesses 247A and 247B, which in turn permits the drive module 14 to be lifted approximately vertically upwardly out of engagement with the interface module 13.

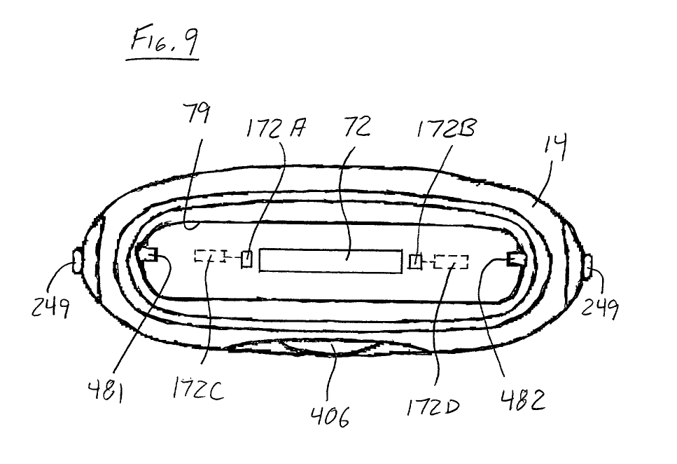

FIG. 9 is a diagrammatic top view of the drive module 14, looking down into the recess 79. On opposite sides of the recess 79 are two guide rails 481 and 482, which each extend approximately vertically down into the recess lengthwise thereof, and which each project inwardly into the recess 79 from opposite sides thereof. The guide rails 481-482 are each slightly offset from the center of the recess 79 in a direction normal to an imaginary plane extending between the guide rails. At the bottom of the recess 79 is the connector 72, which was discussed above in association with FIG. 2.

On opposite sides of the connector 72 are two moveably supported latching pawls 172A and 172B, which are respective parts of the latch portion 172 discussed above in association with FIG. 2. The pawls 172A and 172B are each supported for limited movement toward and away from the connector 72, and are each biased outwardly away from the connector 72 by a respective spring which is not illustrated. The latch portion 172 also includes two electrically actuated solenoids, which are shown diagrammatically at 172C and 172B, and which can each move a respective one of the pawls 172A-172B inwardly toward the connector 72.

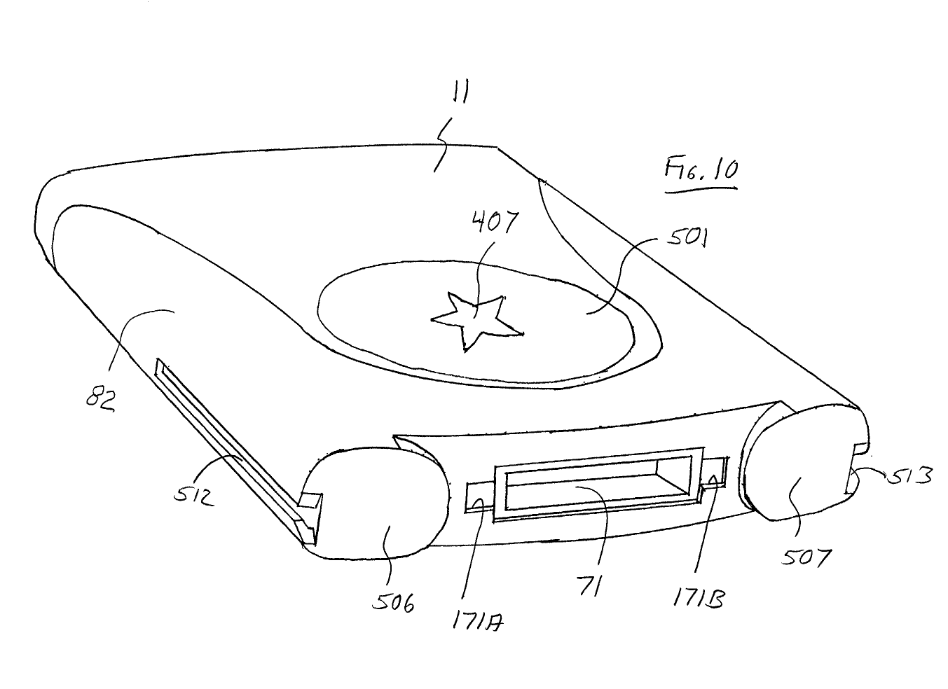

FIG. 10 is a diagrammatic perspective view of the cartridge 11. The cartridge 11 has on one side of its housing 82 a label 501, and the label 501 bears the symbol 407 which was discussed above in association with FIG. 3. As previously discussed, the label 501 could alternatively have some other indica thereon, or could have some additional indicia. At one end, the cartridge housing 82 has two spaced outward projections 506 and 507. The housing 82 has on opposite sides thereof two elongate grooves 512 and 513, which each extend approximately half the length of the cartridge 11, beginning from the end surface of a respective one of the projections 506 and 507. As evident in FIG. 10, the side walls of the grooves 512-513 are flared slightly at the ends of the grooves adjacent the projections 506-507. Also, the grooves 512 and 513 are each offset slightly with respect to the center of the cartridge 11, in a direction normal to an imaginary plane extending between the grooves 512-513.

Between the projections 506 and 507, in the end surface of the cartridge 11, is the connector 71 which was discussed above in association with FIG. 2. On opposite sides of the connector 71, two recesses 171A and 171B are provided in the end surface of the cartridge housing 82. The recesses 171A and 171B are parts of the latch portion 171 which was discussed above in association with FIG. 2.

With reference to FIGS. 9 and 10, the guide rails 481-482 and the slots 512-513 ensure that there is only a single orientation in which the cartridge 11 can be inserted in the recess 79. In particular, since the grooves 512-513 only extend approximately half the length of the cartridge 11, it is not possible to insert the wrong end of the cartridge 11 very far into the recess 79, because the guide rails 481-482 will engage an end surface of the cartridge 11 and prevent further insertion of the cartridge 11 in that orientation.

Moreover, even when the correct end of cartridge 11 is introduced into the recess 79, the cartridge 11 must be oriented so that the label 501 on the cartridge 11 is facing in the same direction as the lens 406 on the drive module 14. This is because, as discussed above, the guide rails 481-482 are slightly offset with respect to a center of the recess 79, and the grooves 512-513 are slightly offset with respect to a center of the cartridge 11. If the label 501 is facing in a direction opposite from the direction in which the lens 406 is facing, there will be a mechanical interference between the guide rails 481-482 and the end surfaces on the projections 506-507, which will prevent significant insertion of the cartridge into the recess 79.

When the cartridge 11 is inserted into the recess 79 with the proper orientation, the flared side surfaces of the grooves 512 and 513 help guide the upper ends of the guide rails 481-482 into the grooves 512-513. Thereafter, the guide rails 581-582 and the grooves 512-513 cooperate in a manner which serves two functions. First, they ensure that the connectors 71 and 72 will be accurately aligned as they move into engagement with each other. Second, the cooperation between the guide rails and grooves has the effect of positioning the cartridge 11 within the recess 79 in a manner so that the exterior surfaces of the cartridge 11 are spaced from and do not rub against the internal surfaces of the recess 79, except to the extent that surfaces on the guide rails 481-482 engage surfaces within the grooves 512-513. Thus, even after the cartridge 11 has been inserted into and removed from the drive module 14 many times, most of the exterior surface of the cartridge 11 will still look very new, rather than being highly scuffed.

As the cartridge 11 is being removably inserted into the recess 79, and as the connectors 71-72 move into mating engagement, the pawls 172A and 172B of the drive module 14 respectively move into the recesses 171A and 171B, and are temporarily deflected inwardly by edges of the recesses as they enter the recesses. Then, as the connectors 71-72 reach proper mating engagement, the pawls 172A and 172B reach positions where they move outwardly so that locking edges thereon engage edges of the recesses 171A-171B in a manner which prevents manual withdrawal of the cartridge 11 from the drive module 14.

In order to remove the cartridge 11 from the drive module 14, an operator must manually press the eject button 301 (FIGS. 2 and 4). As discussed above in association with FIG. 2, the interface circuit 281 responds by waiting until an appropriate time, and then generates a signal through line 91, connectors 242-241 and line 175 to the latch portion 172. This signal actuates the solenoids 172C and 172D (FIG. 9), which in turn effect inward movement of the pawls 172A and 172B in a manner which releases their latching engagement with the recesses 171A and 171B. The cartridge 11 can then be withdrawn from the drive module 14.

The present invention provides a number of technical advantages. One such technical advantage is that, since the cartridge is inserted downwardly into the drive module in an approximately vertical direction, the manual force used in inserting the cartridge will have primarily a vertical component and only a minimal horizontal component. This has the effect of minimizing the extent to which the information storage device is urged to slide horizontally along the surface on which it is resting. A related advantage is that, because the tendency for the device to slide sideways is minimized, larger manual forces can be applied to effect the insertion of the cartridge, as a result of which the connectors used between the cartridge and drive module can be selected to have higher contact and swiping forces, which in turn ensures a more reliable and robust electrical coupling between the cartridge and the drive module.

Another advantage is that the approximately vertical insertion of the cartridge and the approximately vertical orientation of the drive module permit the entire information storage device to have a relatively small footprint on the table top or other surface that supports the device. Still another advantage is that, since the cartridge is removed in a vertically upward direction, there is a reduced likelihood that the cartridge will pop out of the drive module and fall to the floor as it is being released for removal. A related advantage is that the eject button is oriented so as to be actuated vertically, which also minimizes the extent to which the information storage device tends to be urged to slide horizontally across the surface on which it is resting as an operator attempts to initiate cartridge removal.

Another advantage relates to the highlighting of indicia provided on the cartridge using structure provided on the drive module, such as a magnifying lens and/or a light source. Still another advantage relates to the provision on the drive module of a display which provides status information regarding the operation of the information storage device. A related advantage is that, although the display is physically part of the drive module, it is visible through a window in the interface module so as to give the appearance that the display is part of the interface module.

Still another advantage results from the provision of interchangeable interface modules which are each compatible with a single drive module, so as to permit the information storage device to be readily adapted for communication according to various different protocols at minimal expense, in a manner which is simple and convenient. Yet another advantage relates to the fact that the interface module and drive module are configured so that each appears to be incomplete and non-functional when viewed by itself, but that they appear to be a complete and functional unit when they are connected together.

Still another advantage results from the provision of three points of contact between the housings of the interface module and drive module, in order to accurately and reliably establish proper orientation between the housings of these two modules. Another advantage results from the provision on the interface module of at least two connectors which use the same protocol, thereby permitting the information storage device to be daisy chained with other devices, in order to avoid the need for devices of the type commonly known as repeater or hubs.

Still another advantage results from a configuration of guide rails and slots which prevent a cartridge from being inserted into the drive unit with any orientation other than a single correct orientation. A related advantage results from configuration of the guide rails and grooves in a manner so that the only engaging surfaces on the housings of the cartridge and drive module are surfaces on the guide rails and surfaces within the grooves. As a result, other exterior surfaces of the housing of the cartridge are spaced from interior surfaces of the recess in the drive module, and do not become scuffed as the cartridge is repeatedly inserted and removed from the drive module, thereby maintaining the cartridge in a more aesthetically pleasing condition throughout its operational lifetime.

Although one embodiment of the invention has been illustrated and described in detail, it will be understood that various substitutions and alterations can be made therein without departing from the spirit and scope of the present invention, as defined by the following claims.

What is claimed is:

1. An apparatus comprising a receiving unit which includes:
structure for supporting said receiving unit as a freestanding unit on an upwardly facing surface;
a port for facilitating communication with a host system; and
a cartridge receiving portion that can removably receive an information storage cartridge, said cartridge receiving portion being configured so that cartridge insertion and removal is effected in directions which are substantially vertical.

2. An apparatus according to claim 1, wherein said cartridge receiving portion is configured so that said directions of cartridge insertion and removal extend at an angle in the range of 10° to 15° with respect to a vertical reference.

3. An apparatus according to claim 1, wherein said cartridge receiving portion includes a connector engagable with a cartridge connector, and configured to have high contact and swiping forces in order to ensure reliable electrical coupling between said connector of said cartridge receiving portion and a cartridge connector.

4. An apparatus according to claim 1,
wherein said cartridge receiving portion includes a releasable locking structure which facilitates a releasable locking of a cartridge within said cartridge receiving portion; and
wherein said receiving unit includes a button supported for substantially vertical movement, and structure responsive to manual movement of said button in a downward direction for effecting a release of said locking structure.

5. An apparatus according to claim 1, wherein said receiving unit has a vertical dimension which is substantially greater than a maximum dimension of said receiving unit in any horizontal direction.

6. An apparatus comprising a receiving unit which includes:
a port for facilitating communication with a host system;
a cartridge receiving portion that can removably receive an information storage cartridge; and
a display which provides status information regarding operation of said receiving unit.

7. An apparatus according to claim 6, wherein said display includes a liquid crystal display (LCD) device.

8. An apparatus according to claim 6, wherein said receiving unit includes a drive module and an interface module which are releasably coupled to each other, said drive module including said display and said cartridge receiving portion, and said interface module including said port.

9. An apparatus according to claim 8, wherein said interface module includes circuitry which controls said display of said drive module.

10. An apparatus according claim 8, wherein said display is disposed within said interface module when said drive and interface modules are releasably coupled, and wherein said interface module has an opening through which said display is externally visible.

11. An apparatus comprising a receiving unit which includes:
a cartridge receiving portion that can removably receive a cartridge; and
structure configured to highlight indicia present on a cartridge disposed in said cartridge receiving portion.

12. An apparatus according to claim 11, wherein said structure includes a magnifying lens supported on said cartridge receiving portion in a manner so that the indicia is viewed therethrough.

13. An apparatus according to claim 11, wherein said structure includes a light source supported on said cartridge receiving portion so that light therefrom illuminates the indicia.

14. An apparatus according to claim 13, wherein said structure further includes a magnifying lens supported on said cartridge receiving portion in a manner so that the indicia is viewed therethrough.

15. An apparatus comprising a receiving unit which includes:
a cartridge receiving portion that can removably receive an information storage cartridge; and
first and second ports which each facilitate communication according to a common protocol.

16. An apparatus according to claim 15, wherein said first port is configured to facilitate communication with a host system, and said second port is configured to be coupled to a further device, said receiving unit being operable to control the allocation of bandwidth available through said first port between itself and said second port.

17. An apparatus according to claim 15, wherein said first port is configured to facilitate communication with a host system, and said second port is configured to be coupled to a further device, and wherein said receiving unit provides power to said second port from a source other than power available at said first port.

18. An apparatus according to claim 15, wherein said common protocol is one of the IEEE 1394 protocol, the Universal Serial Bus (USB) protocol, the Small Computer System Interface (SCSI) protocol, and the Personal Computer Memory Card International Association (PCMCIA) protocol.

19. An apparatus comprising a receiving unit which includes a drive module, an interface module, and structure operable to releasably couple said drive and interface modules together, said drive module including a cartridge receiving portion that can removably receive an information storage cartridge, and said interface module including a port which facilitates communication with a host system.

20. An apparatus according to claim 19, wherein said interface module includes an interface circuit which is operable to communicate through said port according to a first communication protocol, and which is operable to communicate with said drive module according to a second communication protocol different from said first communication protocol.

21. An apparatus according to claim 20, including a further interface module which can be releasably coupled to said drive module in place of said interface module which communicates according to said first and second protocols, said further interface module having a further port for facilitating communication with a host system, having a further interface circuit which is operable to communicate with said drive module according to said second protocol and which is operable to communicate through said further port according to a third protocol different from each of said first and second protocols.

22. An apparatus according to claim 19,
wherein said drive module includes circuitry operable to facilitate at least one of reading data from and writing data to a cartridge inserted in said cartridge receiving portion; and
wherein said interface module includes an interface circuit which is operable to provide all control intelligence for operation of said receiving unit, including control of said circuitry in said drive module.

23. An apparatus according to claim 22, wherein said interface circuit is operable to provide all control intelligence needed to facilitate removal and insertion of a cartridge with respect to said cartridge receiving portion.

24. An apparatus according to claim 19, wherein said receiving unit includes at least one manually operable button which facilitates a release of said releasable coupling between said drive and interface modules, so that said drive and interface modules can be separated.

25. An apparatus according to claim 19, wherein said drive and interface modules are each configured to have the appearance of an incomplete and non-functional part when decoupled from each other, and to have the appearance of a complete and functional unit when releasably coupled to each other to form said receiving unit.

26. An apparatus according to claim 19, wherein said drive and interface modules each have a housing, and wherein said housings are configured to contact other at three spaced points when said drive and interface modules are releasably coupled, said three points of contact causing said housings to have a selected orientation with respect to each other.

27. An apparatus comprising:
an information storage cartridge having a housing with an exterior surface thereon, and having a mass information storage media within said housing;
a receiving unit which includes a cartridge receiving portion that can removably receive said cartridge, said receiving portion including a recess which receives at least a portion of a cartridge; and
cooperating guide structure on said housing and within said recess which guides insertion of said cartridge into said recess in a manner so that said exterior surface of said cartridge housing, which is separate from said guide structure, is free from contact with said cartridge receiving portion.

28. An apparatus according to claim 27, wherein said cartridge has first and second grooves on opposite sides thereof which extend parallel to a direction of insertion of said cartridge into said recess in said cartridge receiving portion, and wherein said cartridge receiving portion includes first and second guide rails which are disposed within said recess and which are each slidably received within a respective said groove during cartridge insertion, each said guide rail having a height which is greater than a depth of the associated groove.

29. An apparatus comprising:
an information storage cartridge which contains a mass information storage media and which has a connector; and
a receiving unit which includes a connector and a cartridge receiving portion with a recess that can removably receive said cartridge, said connectors being in engagement when said cartridge is removably received in said cartridge receiving portion, and wherein said cartridge and said cartridge receiving portion include cooperating guide structure which facilitates alignment of said connectors during cartridge insertion and which prevents insertion of said cartridge into said cartridge receiving portion with an incorrect orientation, said guide structure including at least two guide rails which extend parallel to a direction of insertion and which are each provided on a respective one of said cartridge and said cartridge receiving portion, and at least two grooves which are each provided on the other of said cartridge and said cartridge receiving portion, and which each slidably receive a respective said guide rail.

30. An apparatus according to claim 29, wherein said grooves and said guide rails are positioned with an offset in relation to a center of said cartridge and a center of said recess of said cartridge receiving portion, in order to facilitate prevention of insertion of said cartridge with an incorrect orientation.

31. An apparatus according to claim 29, wherein said grooves are provided in said cartridge and extend along only a portion of a length of said cartridge, to facilitate prevention of insertion of said cartridge with an incorrect orientation.
